(19) United States
(12) Patent Application Publication
(10) Pub. No.: US 2017/0082207 A1
(43) Pub. Date: Mar. 23, 2017

(54) Adjustable Reusable Flow Regulator

(71) Applicant: Daniel M. Tran, San Diego, CA (US)

(72) Inventor: Daniel M. Tran, San Diego, CA (US)

(21) Appl. No.: 14/862,137

(22) Filed: Sep. 22, 2015

(51) Int. Cl. F16K 3/16; F16K 3/02

(52) U.S. Cl. CPC F16K 3/16; F16K 3/0254; F16K 3/0272

(57) ABSTRACT

An adjustable reusable flexible flow regulation and clamping element is described. The flow regulation and clamping element includes a first flexible hinge. The flow regulation element further includes a locking element and a set of receptacles. The set of receptacles includes multiple notches, each of which is able to receive and retain the locking element. A flow regulation clamp includes a locking element, a flexible hinge coupled to the locking element, and first and second compression surfaces, each surface coupled to the flexible hinge. An adjustable clamp that includes a locking element, a plurality of locking receptacle, first and second flexible hinges, and first and second compression surfaces. The flow regulation element may be able to be used in a range of applications, including toilet fill, irrigation, wearable hydration, hydroponics, etc.

### BACKGROUND

A typical toilet typically includes a tank fill valve and a bowl fill valve. Such valves (and/or other throughways) may provide essentially the same rate of fill.

In most applications, the capacity of the tank and the bowl of a toilet are not equal. Thus, with equal fill rates, the bowl will typically overflow while the tank is filled, causing excessive water usage. Existing solutions may require users to perform extensive installation procedures (e.g., by cutting hoses) and thus may not be removed without requiring repair or replacement the original components. In addition, existing solutions may not be reusable.

Many other applications (e.g., water bottle transport, hydration pack flow, irrigation, etc.) may require adjustable flow regulators.

Thus there exists a need for a reusable adjustable flow regulator that is easy to install and adjust and may be reused with affecting previous installations.

### SUMMARY

Some embodiments provide a way to regulate flow along a flexible fluid passageway. A flow regulator may include multiple flexible hinges, compression surfaces, and a locking element. The regulator may be able to be applied to a flexible hose or tube to restrict fluid flow through the hose or tube. The regulator may be able to be removed from the hose and reused.

The regulator may be formed from a single piece of flexible plastic. The locking element may include a protruding point and an associated set of locking receptacles or notches that run along a member of the regulator. The locking element may be positioned along the set of receptacles such that a first flexible hinge, coupled to the compression surfaces, is closed. The compression surfaces may thus engage and restrict flow through the flexible tube.

A second flexible hinge may be coupled to a member that includes the set of locking receptacles and a release lever. The second hinge may be opened using the release lever such that the set of locking receptacles disengages the locking element. Thus, the regulator may be released from the fluid passageway and reused.

The preceding Summary is intended to serve as a brief introduction to various features of some exemplary embodiments. Other embodiments may be implemented in other specific forms without departing from the scope of the disclosure.

### BRIEF DESCRIPTION OF THE SEVERAL VIEWS OF THE DRAWINGS

The novel features of the disclosure are set forth in the appended claims. However, for purpose of explanation, several embodiments are illustrated in the following drawings.

FIG. 1 illustrates a perspective view of an adjustable flow regulator according to an exemplary embodiment;

FIG. 2 illustrates a side view of the adjustable flow regulator of FIG. 1 during application to a flow path;

FIG. 3 illustrates a side view of the adjustable flow regulator of FIG. 1 during restriction of a flow path; and

FIG. 4 illustrates a top view of the adjustable flow regulator of FIG. 1 during use in an exemplary application.

### DETAILED DESCRIPTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various inventive features are described below that can each be used independently of one another or in combination with other features. Broadly, some embodiments generally provide ways to regulate or restrict flow along flexible fluid pathways.

A first exemplary embodiment provides an adjustable flow regulator that includes a first flexible hinge and a locking element.

A second exemplary embodiment provides a flow regulation clamp that includes a locking element, a flexible hinge coupled to the locking element, and first and second compression surfaces, each surface coupled to the flexible hinge.

A third exemplary embodiment provides an adjustable clamp that includes a locking element, a plurality of locking receptacle, first and second flexible hinges, and first and second compression surfaces.

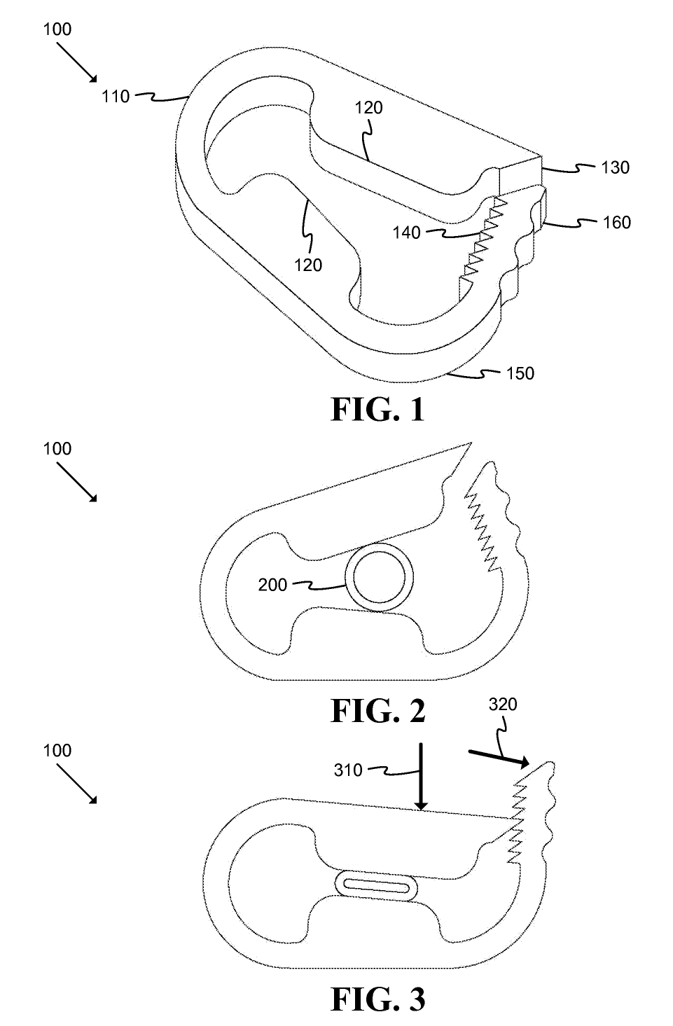

FIG. 1 illustrates a perspective view of an adjustable flow regulator 100 according to an exemplary embodiment. Specifically, this figure shows the flow regulator in an “open” or “unlocked” position. As shown, the regulator includes a flexible hinge 110, multiple compression surfaces 120 that together form a clamping element, a locking element 130, a set of locking notches 140, another flexible hinge 150, and a release lever 160.

The regulator 100 may be formed from an appropriate material and/or combination of materials (e.g., plastic, rubber, etc.). In some embodiments, the regulator may be formed from a single piece of plastic. Such a regulator may be generated using a laser cutting process. The regulator may be formed in various other appropriate ways (e.g., using a mold).

The first flexible hinge 110 may be a section of the regulator 100 of appropriate rigidity and thickness that the hinge is able to be manipulated from a range of positions from fully opened as shown in FIG. 2 (or even extended past that point) to nearly closed as shown in FIG. 3.

Each compression surface 120 may be able to be applied to a hose or other appropriate flexible fluid passageway. Thus, in the open position of FIG. 2 the surfaces 120 contact the outer surface of the hose but do not restrict flow through the hose. The compression surfaces 120 may have different surface shapes or features, as appropriate. In this example, the surfaces are flat and smooth, however some embodiments may include different textures (e.g., gripping or non-slip textures), differently shaped surfaces (e.g., surfaces including notches or other recesses).

The locking element 130 may be able to engage the locking notches 140 in a variety of positions along the range of motion of the regulator 100. In this example, the locking element 130 is an extending point that runs along the full depth of the regulator 100. Different embodiments may include various different locking elements and/or combinations of locking elements (e.g., a releasable zip tie clamp, a point and tooth clamp, a radial clamp, etc.).

Each of the set of locking notches 140 may be an inverted point, as shown, that is capable of receiving and securing the locking element 130. Different embodiments may include different numbers of receptacles 140, and/or differently spaced receptacles along the range of motion of the regulator 100. The type of receptacle 140 may be associated with the type of locking element 130 (e.g., zip tie teeth, radial clamp, etc.). The notches 140 may be coupled to the protruding release lever 160 along a member that extends from hinge 150.

The second flexible hinge 150 may be similar to the first flexible hinge and may allow the set of notches 140 to move as appropriate, as the locking element 130 is positioned along the notches 140 in order to provide a desired amount of flow regulation. Some embodiments may allow flow to be completely stopped (e.g., as during use with a wearable hydration pack).

FIG. 2 illustrates a side view of the adjustable flow regulator 100 during application to a flow path. As shown, a flow pathway 200 such as a flexible tube or hose is in an unrestricted or unregulated state. In addition, the locking element 130 is disengaged from all of the notches 140 and the regulator 100 is thus in a fully open position.

FIG. 3 illustrates a side view of the adjustable flow regulator 100 during restriction of a flow path along tube 200. As shown, the compression surfaces 120 may modify flow through tube 200 by applying compression to portions of the exterior surface of the tube. The compression may be adjusted by moving the locking element 130 along the set of notches 140. Flow restriction may be increased by applying pressure along path 310, thus moving the locking element 130 along the notches 140 such that the locking element 130 engages a next receptacle where the element 130 is secured in place.

The locking element 130 may be released from the notches 140, and the regulator 100 returned to the open position, by applying lateral pressure to the lever 160 along path 320, or otherwise dislodging the locking element 130 from the receptacles 140, as appropriate (e.g., by pressing a lever associated with a reusable zip tie, performing rotary manipulation of a radial clamp element, etc.).

One of ordinary skill in the art will recognize that the regulator of FIGS. 1-3 may be implemented in various different ways without departing from the scope of the disclosure. For instance, different embodiments may include different numbers of locking receptacles. As another example, different embodiments may be sized differently, as appropriate for various different applications. As still another example, some embodiments may be optimized for installation and/or use in various appropriate applications.

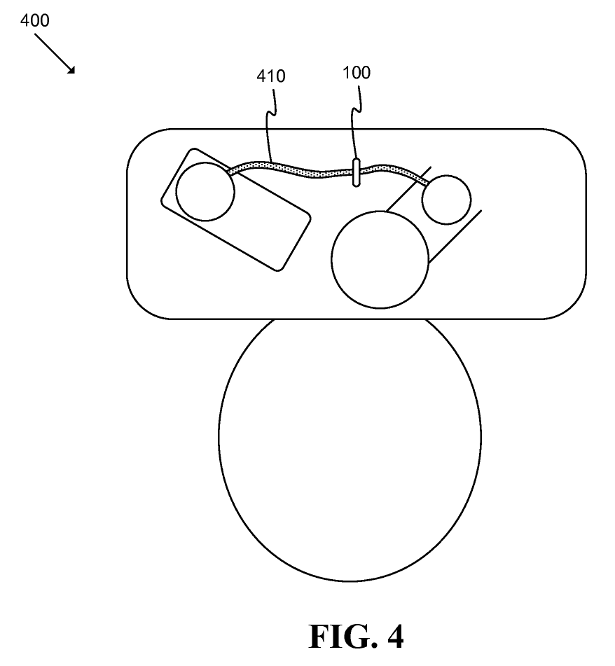

FIG. 4 illustrates a top view of the adjustable flow regulator 100 during use in an exemplary application 400. In this example, the regulator is applied to a hose connecting a bowl fill valve and a tank fill valve of a typical toilet.

Other example applications include, for instance, use as a water bottle (and/or other transportable object) carabiner, use as a regulator for a wearable hydration system (e.g., a backpack including a drinking water reservoir), use as a regulator for hydration systems associated with a greenhouse and/or hydroponic applications.

Different applications may include differently-sized regulators, appropriate for the size of the flow pathway to be regulated. For instance, a regulator for a toilet application may be roughly one and one-quarter inches by three-quarters of an inch by three-sixteenths of an inch.

The foregoing relates to illustrative details of exemplary embodiments and modifications may be made without departing from the scope of the disclosure as defined by the following claims.

I claim:

1. An adjustable flow regulator comprising:
a first flexible hinge; and
a locking element.

2. The adjustable flow regulator of claim 1 further comprising a set of locking receptacles.

3. The adjustable flow regulator of claim 2, wherein each locking receptacle is able to retain the locking element in a particular position along a range of motion of the first flexible hinge.

4. The adjustable flow regulator of claim 3 further comprising first and second clamping surfaces coupled to the first flexible hinge.

5. The adjustable flow regulator of claim 4, wherein the first clamping surface is coupled to the locking element.

6. The adjustable flow regulator of claim 5, wherein the second clamping surface is coupled to a second flexible hinge.

7. The adjustable flow regulator of claim 6, wherein the second flexible hinge is coupled to the set of locking receptacles.

8. A flow regulation clamp comprising:
a locking element;
a flexible hinge coupled to the locking element; and
first and second compression surfaces, each surface coupled to the flexible hinge.

9. The flow regulation clamp of claim 8 further comprising another flexible hinge coupled to the first compression surface.

10. The flow regulation clamp of claim 8, wherein the locking element comprises a protruding point.

11. The flow regulation clamp of claim 10 further comprising a set of notches able to secure the protruding point along a range of positions.

12. The flow regulation clamp of claim 11 further comprising another flexible hinge coupled to the set of notches.

13. The flow regulation clamp of claim 8, wherein the locking element, the flexible hinge, and the compression surfaces are integrated into a single plastic device.

14. An adjustable clamp comprising:
a locking element;
a plurality of locking receptacle;
first and second flexible hinges; and
first and second compression surfaces.

15. The adjustable clamp of claim 14, wherein the locking element comprises a protruding point.

16. The adjustable clamp of claim 14, wherein the locking receptacles comprise a plurality of notches, each notch able to retain the locking element.

17. The adjustable clamp of claim 14, wherein the first hinge is coupled to the first and second compression surfaces.

18. The adjustable clamp of claim 17, wherein the second hinge is coupled to the locking receptacle.

19. The adjustable clamp of claim 14 further comprising a release lever coupled to the clamping receptacles.

20. The adjustable clamp of claim 14, wherein the first and second flexible hinges rotate about parallel axes.
